(19) United States
(12) Patent Application Publication
(10) Pub. No.: US 2025/0116843 A1
(43) Pub. Date: Apr. 10, 2025

(54) OPTICAL ELEMENT DRIVING MECHANISM

(71) Applicant: TDK TAIWAN CORP., Taoyuan City (TW)

(72) Inventors: Wei-Jhe SHEN, Taoyuan City (TW); Sin-Jhong SONG, Taoyuan City (TW)

(21) Appl. No.: 18/906,576

(22) Filed: Oct. 4, 2024

Related U.S. Application Data
(60) Provisional application No. 63/588,441, filed on Oct. 6, 2023.

(51) Int. Cl. G02B 7/09; G02B 5/00

(52) U.S. Cl. CPC G02B 7/09; G02B 5/005

(57) ABSTRACT

An optical element driving mechanism is provided. The optical element driving mechanism includes a movable part, a fixed part, and a driving assembly. The movable part is for connecting an optical element. The movable part moves relative to the fixed part. The driving assembly is for driving the movable part to move.

### CROSS REFERENCE TO RELATED APPLICATIONS

This application claims the benefit of U.S. Provisional Application No. 63/588,441, filed 2023 Oct. 6, the entirety of which is incorporated by reference herein.

### BACKGROUND OF THE INVENTION

### Field of the Invention

The present invention relates to an optical element driving mechanism, and, in particular, it relates to an optical element driving mechanism with a movable part and a stabilizing assembly.

### Description of the Related Art

With the development of technology, many electronic devices today (such as computers and tablets) have the function of taking photos and recording videos. The use of these electronic devices is becoming increasingly common, and while they have been developed to be more stable and have better optical quality, the design trend is also moving towards making them more convenient with a slim profile, to provide users with more options.

However, when it is necessary to install optical elements (such as lenses) with long focal lengths into the aforementioned electronic devices, this results in an increase in the thickness of the electronic device, which is not advantageous to the slimming and stability of the electronic device. In view of this, designing an optical system that allows electronic devices to be slim and stable has become an important issue.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to certain aspects of the present disclosure, an optical element driving mechanism is provided. The optical element driving mechanism includes a movable part, a fixed part, and a driving assembly. The movable part is for connecting an optical element. The movable part moves relative to the fixed part. The driving assembly is for driving the movable part to move.

According to certain aspects of the present disclosure, the optical element driving mechanism further includes a sensing assembly. The fixed part has a frame and a base. The frame is fixedly connected to the base. The sensing assembly is disposed on the base.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a perspective view of an optical element driving mechanism and an optical element, according to certain aspects of the present disclosure.

FIG. 2 is an exploded perspective view of the optical element driving mechanism and the optical element, according to certain aspects of the present disclosure.

FIG. 3 is a cross-sectional view of the optical element driving mechanism and the optical element along line A-A in FIG. 1, according to certain aspects of the present disclosure.

FIG. 4 is a top view of the optical element driving mechanism and the optical element with the blades in a first position, according to certain aspects of the present disclosure, wherein the top cover and the frame are shown in dashed lines for illustrative purposes.

FIG. 5 is a top view of the optical element driving mechanism and the optical element with the blades in a second position, according to certain aspects of the present disclosure, wherein the top cover and the frame are shown in dashed lines for illustrative purposes.

FIG. 6 is a bottom view of the optical element driving mechanism and the optical element, according to certain aspects of the present disclosure, wherein the base and the movable part are shown in dashed lines for illustrative purposes.

FIG. 7 is a side view of the optical element driving mechanism and the optical element, according to certain aspects of the present disclosure, wherein the frame and the coil are removed for illustrative purposes.

FIG. 8 is a side view of the base and the electronic assembly of the optical element driving mechanism, according to certain features disclosed herein, wherein the base is shown in dashed lines for illustrative purposes.

### DETAILED DESCRIPTION OF THE INVENTION

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The disclosure relates to an optical element driving mechanism, which includes a driving assembly and a guiding assembly that drive the movement of a movable part and an optical element, thereby adjusting the imaging of the optical element driving mechanism to meet different photographic needs.

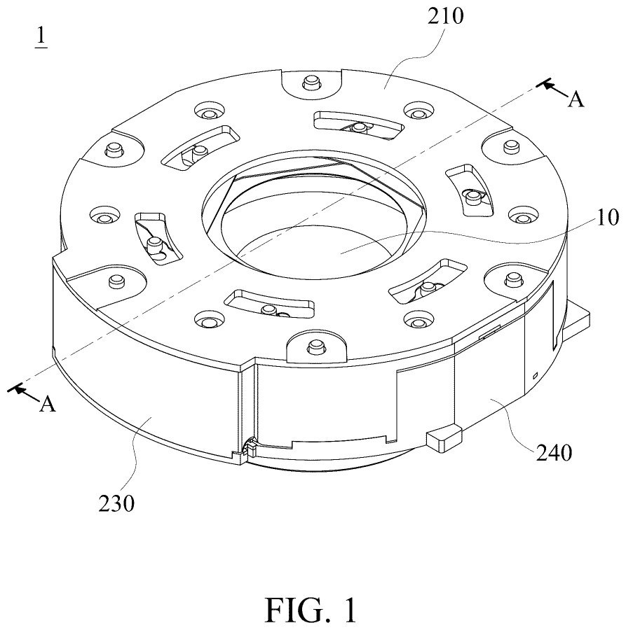

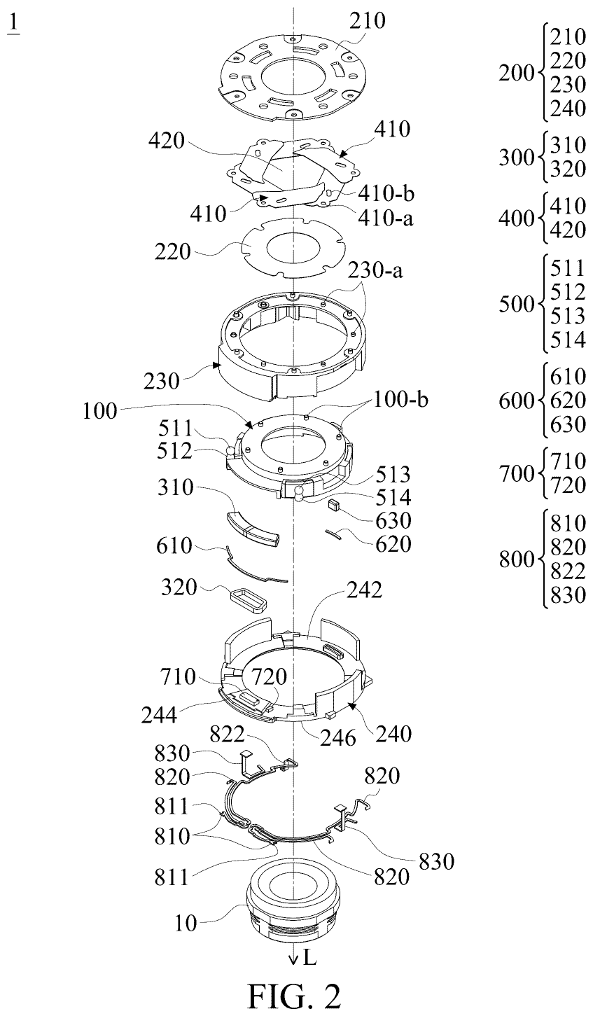

First, please refer to FIG. 1 and FIG. 2. FIG. 1 is a perspective view of an optical element driving mechanism 1 and an optical element 10, according to certain aspects of the present disclosure. FIG. 2 is an exploded perspective view of the optical element driving mechanism 1 and the optical element 10, according to certain aspects of the present disclosure.

The optical element driving mechanism 1 includes a movable part 100, a fixed part 200, a driving assembly 300, an aperture assembly 400, a guiding assembly 500, a stabilizing assembly 600, a sensing assembly 700, and an electronic assembly 800. The movable part 100 is connected to the optical element 10, which may be, for example, an optical lens. The movable part 100 may move relative to the fixed part 200. The driving assembly 300 drives the movement of the movable part 100. The external incident light passes through the optical element driving mechanism 1 in an incident direction L to reach the optical element 10.

The optical element 10 is disposed on a lens driving device (not shown in figures), achieving autofocus (AF) and optical image stabilization (OIS) functions via the lens driving device, which has multiple driving circuit parts (not shown in figures) for driving the lens driving device.

The fixed part 200 includes a top cover 210, a light-blocking element 220, a frame 230, and a base 240.

The top cover 210 is movably disposed on the aperture assembly 400. The aperture assembly 400 is positioned between the light-blocking element 220 and the top cover 210. The top cover 210 at least partially covers the aperture assembly 400 and the optical element 10, thus protecting the elements within the optical element driving mechanism 1 from external impacts. The light-blocking element 220 may be made of a light-absorbing material, such as SOMA.

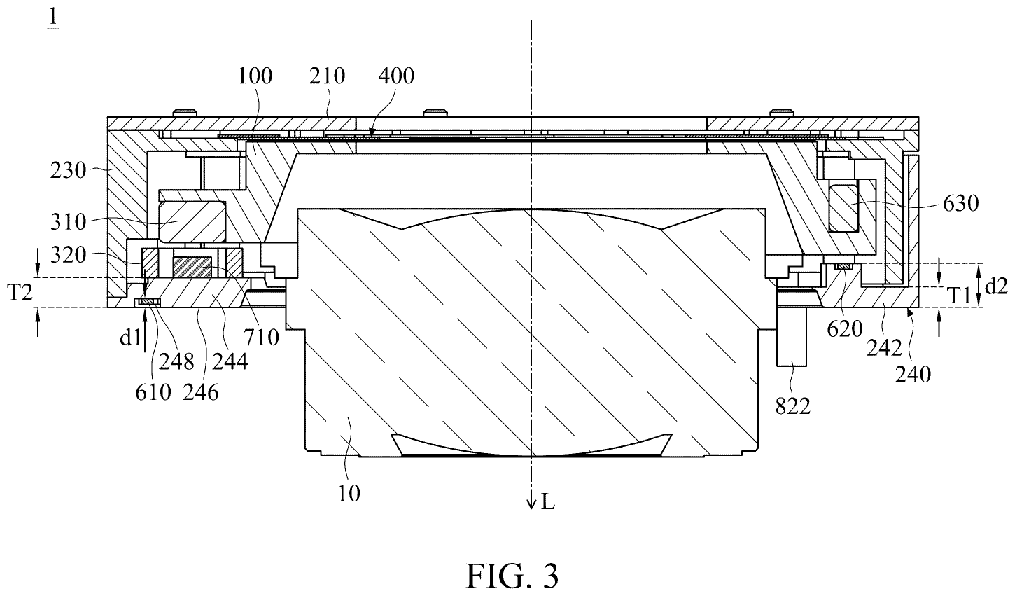

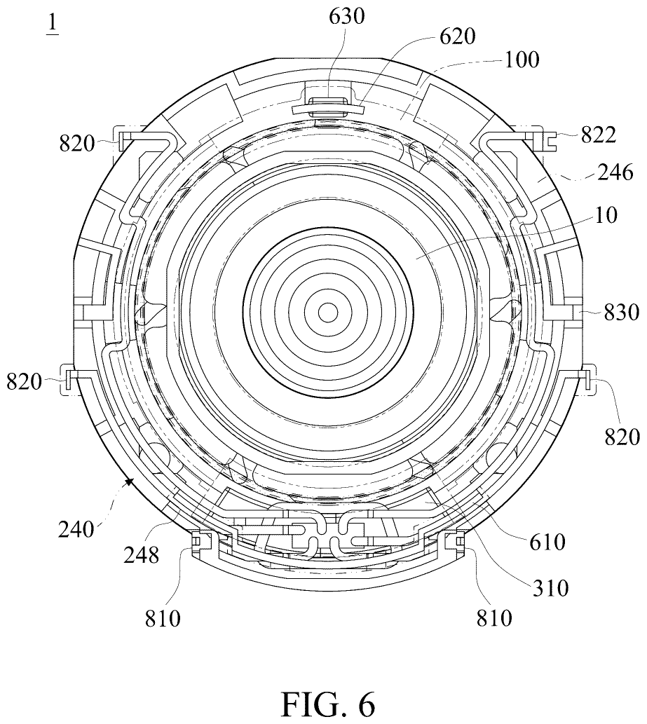

Next, please refer to FIG. 3. FIG. 3 is a cross-sectional view of the optical element driving mechanism 1 and the optical element 10 along line A-A in FIG. 1, according to certain aspects of the present disclosure. The base 240 has a protruding structure 244, a main body 242, and a bottom surface 246. The thickness T1 of the main body 242 is less than the thickness T2 of the protruding structure 244. There is a groove 248 on the bottom surface 246 (shown in FIG. 3 and FIG. 6), accommodating a first magnetic conductive element 610 of the stabilizing assembly 600 (which will be further described below in relation to FIG. 3 and FIG. 6).

When observed along the incident direction L of the incident light, the frame 230, the movable part 100, the driving assembly 300, the sensing assembly 700, and the base 240 are arranged sequentially.

Next, please continue to refer to FIG. 2. The driving assembly 300 includes a first magnetic element 310 and a coil 320.

The first magnetic element 310 is disposed on the movable part 100. The coil 320 is disposed on the protruding structure 244 of the base 240. The coil 320 has a trapezoidal structure that corresponds to the arc trapezoidal structure of the first magnetic element 310.

By the electromagnetic driving force generated between the first magnetic element 310 and the coil 320, the first magnetic element 310 moves relative to the coil 320. As a result, the movable part 100 moves relative to the base 240, driving the movement of the aperture assembly 400. Thus, the electromagnetic driving force generated between the first magnetic element 310 and the coil 320 may drive the movable part 100 to move the aperture assembly 400 relative to the base 240.

The aperture assembly 400 has a plurality of blades 410. In this embodiment, there are six blades 410. The six blades 410 form an opening 420 through which the incident light enters the optical element 10.

The guiding assembly 500 includes a plurality of blades guiding elements. In this embodiment, there are four guiding elements 511, 512, 513, and 514, disposed between the movable part 100 and the frame 230, adjacent to the first magnetic element 310. The movable part 100 is connected to the frame 230 via the four guiding elements 511, 512, 513, and 514. The guiding elements 511, 512, 513, and 514 are movably connected to the frame 230 and the movable part 100.

When the movable part 100 is driven by the driving assembly 300 to move, the guiding elements 511, 512, 513, and 514 roll between the frame 230 and the movable part 100, allowing the movable part 100 to move smoothly relative to the frame 230.

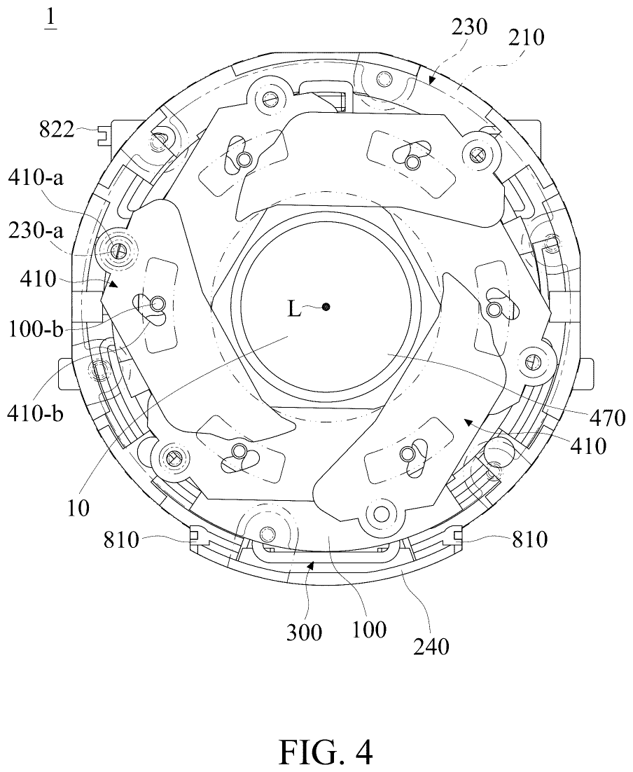

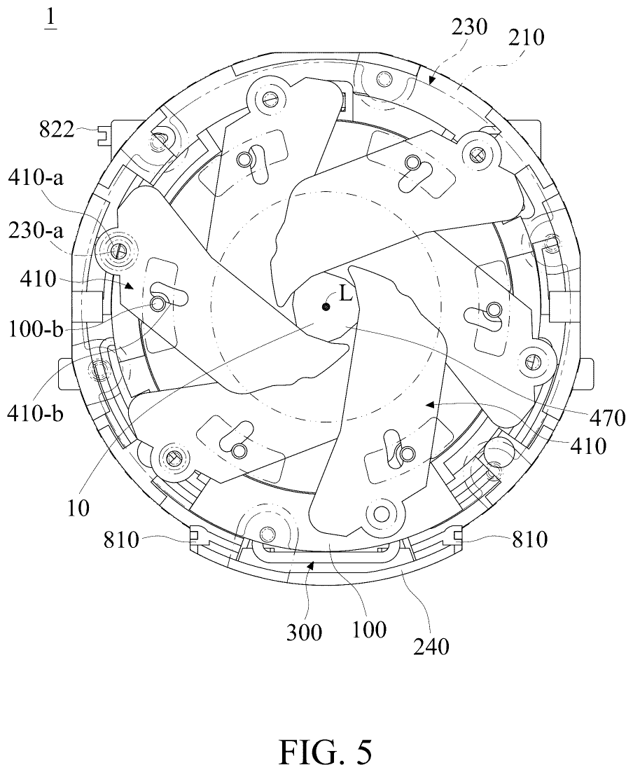

The movement of the movable part 100 relative to the frame 230 is now described with reference to FIG. 4 and FIG. 5. FIG. 4 is a top view of the optical element driving mechanism 1 and the optical element 10 with the blades 410 in a first position, according to certain aspects of the present disclosure, wherein the top cover 210 and the frame 230 are shown in dashed lines for illustrative purposes. FIG. 5 is a top view of the optical element driving mechanism 1 and the optical element 10 with the blades 410 in a second position, according to certain aspects of the present disclosure, wherein the top cover 210 and the frame 230 are shown in dashed lines for illustrative purposes.

The movable part 100 is connected to the six blades 410. Each blade 410 has a hole 410-a and an elongated hole 410-b for connecting the movable part 100 and the frame 230, as will be further explained below.

The movable part 100 and the blades 410 may move relative to the frame 230. The movable part 100 has a plurality of blades protrusions 100-b that pass through the elongated holes 410-b of the blades 410 and may move within these elongated holes 410-b.

The frame 230 has a plurality of blades protrusions 230-a that pass through the holes 410-a of the blades 410 and may rotate within these holes 410-a. Through the protrusions 100-b and 230-a and the elongated holes 410-b and holes 410-a, the blades 410 connect the movable part 100 and the frame 230.

When the movable part 100 is driven by the driving assembly 300 to move, the multiple protrusions 100-b of the movable part 100 move within the elongated holes 410-b of the blades 410, and the multiple protrusions 230-a of the frame 230 rotate within the holes 410-a of the blades 410. The movable part 100 thereby drives the movement of the blades 410. Through the movement of the blades 410, the size of the opening 420 formed by the blades 410 may be adjusted.

When the blades 410 are in the first position shown in FIG. 4, the opening 420 formed by the blades 410 is larger, allowing a greater amount of incident light to pass through the opening 420 to reach the optical element 10.

When the blades 410 are in the second position shown in FIG. 5, the opening 420 formed by the blades 410 is smaller than in the first position shown in FIG. 4, resulting in a lower amount of incident light reaching the optical element 10 through the opening 420 compared to the first position.

Next, please refer to both FIG. 3 and FIG. 6. FIG. 6 is a bottom view of the optical element driving mechanism 1 and the optical element 10, according to certain aspects of the present disclosure, wherein the base 240 and the movable part 100 are shown in dashed lines for illustrative purposes.

The stabilizing assembly 600 includes a first magnetic conductive element 610, a second magnetic conductive element 620, and a second magnetic element 630.

The first magnetic conductive element 610 corresponds to the first magnetic element 310 and is disposed in the groove 248 of the base 240. The second magnetic conductive element 620 is disposed on the base 240, corresponding to the second magnetic element 630. The second magnetic element 630 is a plurality of blades on the movable part 100, on the opposite side of the first magnetic element 310. The second magnetic element 630 is sized differently than the first magnetic element 310. In this embodiment, the second magnetic element 630 is smaller than the first magnetic element 310. The second magnetic element 630 provides an additional magnetic attraction to stabilize the structure of the movable part 100.

The first magnetic conductive element 610 and the first magnetic element 310 provide magnetic attraction for the movable part 100 along the incident direction L and towards the guiding assembly 500, allowing the movable part 100 to lean against the guiding assembly 500, thereby stabilizing the movement of the movable part 100 relative to the frame 230.

The second magnetic conductive element 620 and the second magnetic element 630 provide magnetic attraction for the movable part 100 along the incident direction L, with this torque balancing the torque of the magnetic attraction between the first magnetic conductive element 610 and the first magnetic element 310. Therefore stabilizing the structure between the movable part 100 and the fixed part 200.

The distance d1 between the first magnetic conductive element 610 and the bottom surface 246 differs from the distance d2 between the second magnetic conductive element 620 and the bottom surface 246. The distance d1 between the first magnetic conductive element 610 and the bottom surface 246 is less than the distance d2 between the second magnetic conductive element 620 and the bottom surface 246. The first magnetic conductive element 610 includes a first section, a second section, and a third section. The second section and the third section are formed respectively at the two ends of the first section. When observed along the incident direction L, the distance from the first section of the first magnetic conductive element 610 to the incident direction L differs from the distance from the second section and the third section of the first magnetic conductive element 610 to the incident direction L. The distance from the first section of the first magnetic conductive element 610 to the incident direction L is greater than the distance from the second section and the third section of the first magnetic conductive element 610 to the incident direction L.

When observed along the incident direction L, the center of the first magnetic element 310 does not overlap the center of the first magnetic conductive element 610. The first section of the first magnetic conductive element 610 does not overlap the first magnetic element 310, while the second section and the third section of the first magnetic conductive element 610 at least partially overlap the first magnetic element 310. The center of the second magnetic element 630 overlaps the center of the second magnetic conductive element 620.

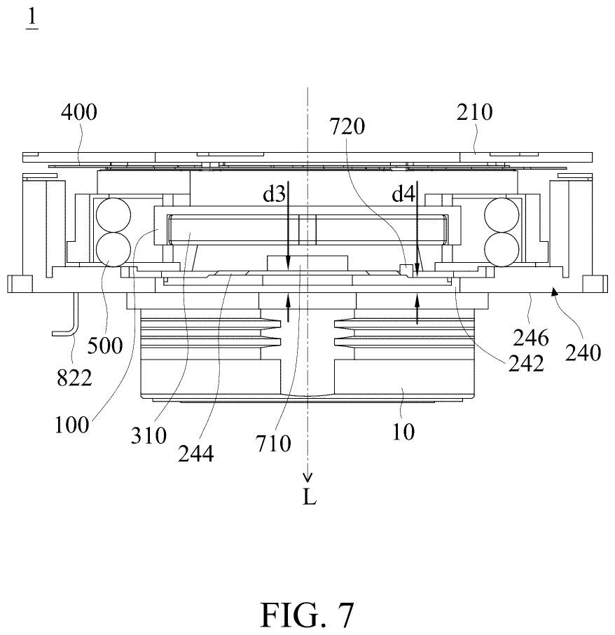

Next, please refer to FIG. 7. FIG. 7 is a side view of the optical element driving mechanism 1 and the optical element 10, according to certain aspects of the present disclosure, wherein the frame 230 and the coil 320 are removed for illustrative purposes.

The sensing assembly 700 includes a first electronic element 710 and a second electronic element 720. The first electronic element 710 is disposed on the protruding structure 244, while the second electronic element 720 is disposed on the main body 242.

The distance d3 between the first electronic element 710 and the bottom surface 246 of the base 240 differs from the distance d4 between the second electronic element 720 and the bottom surface 246. The distance d3 between the first electronic element 710 and the bottom surface 246 is smaller, making the sensing signal more stable when the first electronic element 710 detects the first magnetic element 310.

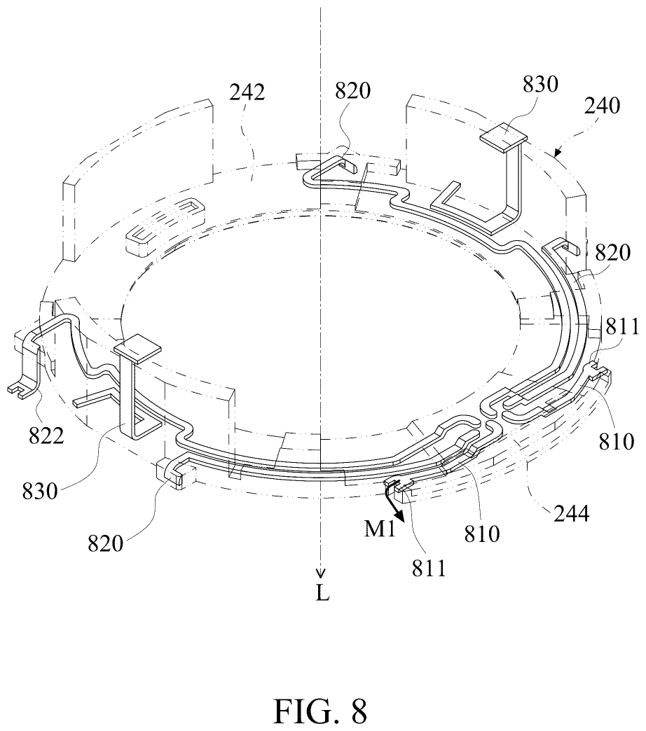

Next, please refer to both FIG. 2 and FIG. 8. FIG. 8 is a side view of the base 240 and the electronic assembly 800 of the optical element driving mechanism 1, according to certain features disclosed herein, wherein the base 240 is shown in dashed lines for illustrative purposes.

The electronic assembly 800 is disposed on the base 240, and is electrically connected to the driving assembly 300. The electronic assembly 800 includes a plurality of first external ends 810, a plurality of second external ends 820, 822, and a plurality of third electronic elements 830. The third electronic elements 830 are connected to the second external ends 820.

The first external ends 810 protrude from the base 240. The first external ends 810 each have a groove 811. When the first external ends 810 connect to an external circuit (for example, the driving circuit part of the lens driving device), the first external ends 810 connects a metal element M1. The grooves 811 allow the metal element M1 to extend in the direction of the incident light L within the groove 811. As a result, the grooves 811 allows the metal element M1 to be disposed more easily and reduces the risk of excessive bending that could lead to breakage.

The second external ends 820 and 822 protrude from the base 240 and connect to an external circuit (for example, the driving circuit part of the lens driving device). In some embodiments, the second external ends 820 may extend in the direction of the incident direction L, similar to the second external end 822 (as shown in FIG. 7 and FIG. 8, where the second external end 822 is configured to extend in the direction of the incident direction L). The extension length and direction of the second external ends 820 and 822 may be configured according to the needs of the connected devices.

This configuration is beneficial for the installation of the optical element driving mechanism 1 on the lens driving device. Specifically, in this embodiment, the lens driving device equipped with the optical element 10 does not require additional circuit for driving the movable part 100 and the aperture assembly 400, thereby simplifying the structural design of the lens driving device. Additionally, with the first external end 810, second external ends 820, 822, and third electronic element 830 of the electronic assembly 800, the driving circuit part of the lens driving device may also be disposed on the base 240, making the circuit design for controlling the optical element driving mechanism 1 and the lens driving device more convenient and simple.

In summary, the present disclosure discloses an optical element driving mechanism that includes a movable part, a fixed part, a driving assembly, an aperture assembly, and a guiding assembly. The movement of the driving assembly drives the movable part to move relative to the fixed part. This allows for adjustment of the position of the blades, controlling the amount of incident light reaching the optical element to meet different photography needs, thereby providing more stable optical quality. Additionally, the design of the frame and electronic assembly enables the optical element driving mechanism to be easily installed on a lens driving device, ensuring that the structural design of the movable part and the aperture assembly is not influenced by the lens driving device, allowing compatibility with lens driving devices of various sizes. Furthermore, the circuit design for driving the movement of the movable part and aperture assembly may be independent from that of the lens driving device, simplifying the design of the control circuits.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments may be made, according to the disclosure herein, without departing from the spirit or scope of the invention. Thus, the breadth and scope of the present invention should not be limited by any of the above described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical element driving mechanism, comprising:
a movable part, for connecting an optical element;
a fixed part, wherein the movable part moves relative to the fixed part; and
a driving assembly, for driving the movable part to move.

2. The optical element driving mechanism as claimed in claim 1, further comprising a sensing assembly, wherein the fixed part has a frame and a base, the frame is fixedly connected to the base, and the sensing assembly is disposed on the base.

3. The optical element driving mechanism as claimed in claim 2, wherein when observed along an incident direction of an incident light, the frame, the movable part, the driving assembly, the sensing assembly, and the base are arranged in sequence.

4. The optical element driving mechanism as described in claim 3, further comprising an electronic assembly, disposed on the base, electrically connected to the driving assembly, wherein the electronic assembly includes:
a first external end, having a groove, protruding from the base; and
a second external end, protruding from the base.

5. The optical element driving mechanism as claimed in claim 4, wherein the first external end is connected to a metal element, and the metal element extends in the incident direction.

6. The optical element driving mechanism as claimed in claim 4, wherein the second external end extends in the incident direction.

7. The optical element driving mechanism as claimed in claim 2, wherein the driving assembly comprises:
a first magnetic element; and
a coil, having a trapezoidal structure, corresponding to the first magnetic element; wherein
the base has a protruding structure and a main body, and the coil is disposed on the protruding structure.

8. The optical element driving mechanism as claimed in claim 7, wherein the thickness of the main body is less than the thickness of the protruding structure.

9. The optical element driving mechanism as claimed in claim 7, wherein the sensing assembly includes:
a first electronic element, disposed on the protruding structure; and
a second electronic element, disposed on the main body, wherein
the distance between the first electronic element and a bottom surface of the base is different from the distance between the second electronic element and the bottom surface.

10. The optical element driving mechanism as claimed in claim 9, further comprising a stabilizing assembly, including:
a first magnetic conductive element, corresponding to the first magnetic element;
a second magnetic conductive element; and
a second magnetic element, disposed on the movable part, corresponding to the second magnetic conductive element, wherein
the distance between the first magnetic conductive element and the bottom surface is different from the distance between the second magnetic conductive element and the bottom surface.

11. The optical element driving mechanism as claimed in claim 10, wherein when observed along the incident direction:
the center of the first magnetic element does not overlap the center of the first magnetic conductive element; and
the center of the second magnetic element overlaps the center of the second magnetic conductive element.

12. The optical element driving mechanism as claimed in claim 10, wherein the size of the first magnetic element is greater than the size of the second magnetic element.

13. The optical element driving mechanism as claimed in claim 10, wherein the distance between the first magnetic conductive element and the bottom surface is less than the distance between the second magnetic conductive element and the bottom surface.

14. The optical element driving mechanism as claimed in claim 10, wherein the first magnetic conductive element includes:
a first section;
a second section, and
a third section,
wherein the second section and the third section are formed respectively at the two ends of the first section, and when observed along the incident direction, the distance from the first section of the first magnetic conductive element to the incident direction differs from the distance from the second section and the third section of the first magnetic conductive element to the incident direction.

15. The optical element driving mechanism as claimed in claim 14, wherein the distance from the first section of the first magnetic conductive element to the incident direction is greater than the distance from the second section and the third section of the first magnetic conductive element to the incident direction.

16. The optical element driving mechanism as claimed in claim 14, wherein when observed along the incident direction, the first section of the first magnetic conductive element does not overlap the first magnetic element.

17. The optical element driving mechanism as claimed in claim 14, wherein when observed along the incident direction, the second section and the third section of the first magnetic conductive element at least partially overlap the first magnetic element.
